(19) United States
(12) Patent Application Publication
(10) Pub. No.: US 2004/0012837 A1
(43) Pub. Date: Jan. 22, 2004

(54) Programmable acousto-optic device

(76) Inventors: Daniel Kaplan, Paris (FR); Thomas Oksenhendler, Paris (FR); Pierre Tournois, Cagnes S/Mer (FR)

Correspondence Address: William A Drucker, 1299 Pennsylvania Avenue NW, Washington, DC, 20004, US

(21) Appl. No.: 10/311,897

(22) PCT Filed: Jun. 8, 2001
(86) PCT No.: PCT/FR01/01796

(30) Foreign Application Priority Data
Jun. 21, 2000 (FR) 00/08278

(51) Int. Cl. G02F 1/11

(52) U.S. Cl. 359/285; 359/286

(57) ABSTRACT

The invention concerns a device comprising a birefringent elasto-optic medium (1) equipped with a transducer (5) generating in the medium (1) a modulated acoustic wave along a specific direction, and means for coupling in the medium (1) an input optical wave with unknown polarisation, and a programming circuit for (amplitude-phase-frequency) modulation of the acoustic wave. Said device supplies a direct wave and two perpendicular diffracted waves of H, V polarisation each bearing a modulation based on the input optical wave modulation and the acoustic wave modulation.

The present invention concerns a programmable acousto-optic device for controlling the amplitude of the spectrum in the wavelengths of wavelength-multiplexed optical communications systems.

Generally speaking, it is known that certain optical communications systems use the “Wavelength Division Multiplexing” (WDM) technique. According to this technique, the information intended for a subscriber or more generally for a transmission channel are borne by a particular wavelength, and a large number of channels, that is with wavelengths, can be used at the same time.

Normally, it is desirable that the light levels transmitted on each of the channels, that is on each of the wavelengths, are equal. This is in particular essential in the case of digital transmissions where the logic levels are defined by light levels.

Now the light sources possess slow fluctuations over a period of time, the optical fibres do not transmit all the wavelengths with the same intensity, the modulators exhibit absorption at the short wavelengths, the communication network is modified over a period of time, and finally the amplifiers with fibres doped with Erbium do not amplify all the wavelengths of the WDM spectrum in the same way.

Thus, the problem to be resolved is the programmable equalisation of the light intensity for all the channels, especially downstream of the fibre amplifiers. Several electronic and optical adaptable equalisation techniques have been put forward. All are quite complex, sensitive to polarisation of the optical input wave and are scarcely termed as high-performing, either in terms of passband and insertions losses or in terms of dynamics and quality of equalisation.

The main object of the invention is to resolve these problems by means of a programmable acousto-optic filter called hereafter AOPEF (Acousto Optic Programmable Equalization Filter) for shaping or equalizing the amplitude of the various channels contained in the spectrum of wavelength-multiplexed optical communications systems.

To this effect, the invention generally aims to provide a programmable acousto-optic device including a double refracting elasto-optical medium provided with a transducer capable of generating inside the elasto-optical medium an acoustic wave modulated along a specific direction, as well as means for coupling in the elasto-optical medium an optical input wave with unknown polarisation with unknown components H and V projected onto the fast and slow axes of the double refracting medium.

According to the invention, this device is characterised in that it comprises a circuit for programming the amplitude/frequency or phase modulation of the acoustic wave and provides three output optical waves: one direct wave with the same polarisation as the input optical wave, and two diffracted waves with polarisation II and V respectively perpendicular to each other and each bearing an amplitude and frequency or phase modulation of their spectrum which depends on both the modulation of the optical input wave and modulation of the acoustic wave, modulation of the spectrum of the acoustic wave being able to be programmed so as to compensate the amplitude distortions or to modify the shape of the spectrum of the various transmission channels of wavelength-multiplexed optical communications systems.

According to a first variant of the invention, the effective optic output beam bearing the result of shaping or equalization is the non-diffracted transmitted direct beam.

According to a second variant of the invention, the two diffracted output waves with polarisation H and V are recombined according to a sole polarisation output wave basically identical to that of the optical input wave.

Moreover, the device of the invention could comprise an adapting device including a measurement of the optical spectrum at the outlet of the device or a measurement of the response of the transmission channels and a counter-reaction circuit acting on the programming circuit of the device so as to equalise or optimise the optical energy in all channels.

Advantageously, one portion of the spectrum of modulation of the acoustic wave is used to shape or equalise the component H of polarisation of the incident optical wave, whereas another separate portion of the spectrum of modulation of the acoustic wave is used to shape or equalise the component V of polarisation of the incident wave.

The direction of propagation of the energy of the acoustic wave could be collinear or quasi collinear with the direction of propagation of the energy of the optical input wave in their interaction zone.

Modulation of the acoustic wave could comprise phase which varies over a period of time randomly or pseudo-randomly with a correlation time much shorter than the acoustic propagation time in the crystal.

The periodic acoustic signal could have a period equal to the acoustic propagation time in the interaction zone of the crystal.

Advantageously, the device of the invention could be placed downstream of the fibre amplifiers dosed with Erbium.

The principle and the embodiments of the invention shall now be described hereafter and given by way of non-restrictive example with reference to the accompanying drawings on which:

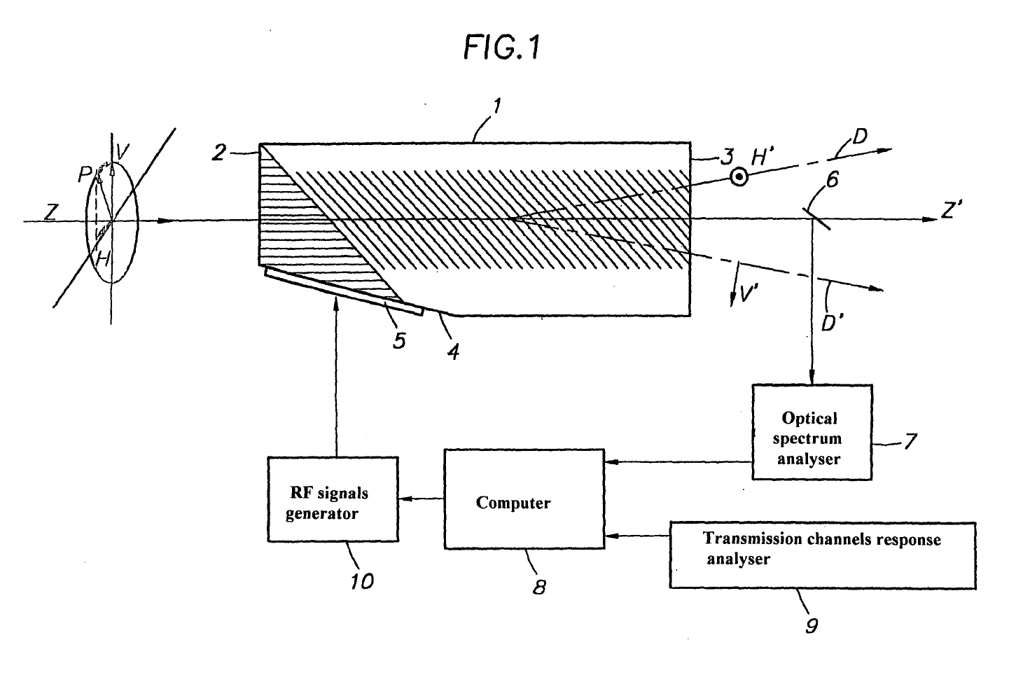

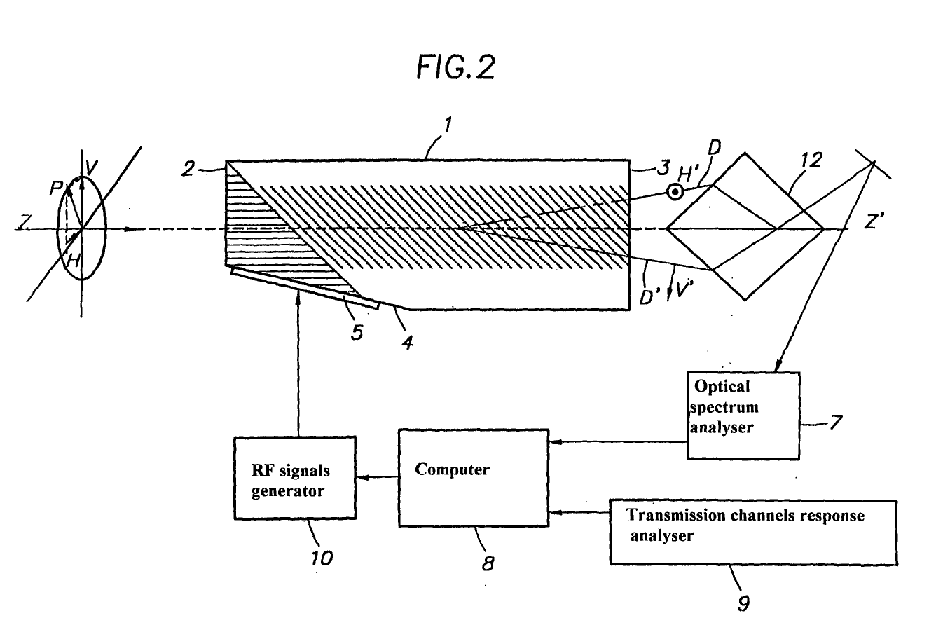

FIGS. 1 and 2 are diagrammatic representations of two variants of a light modulation device by means of an acousto-optic interaction;

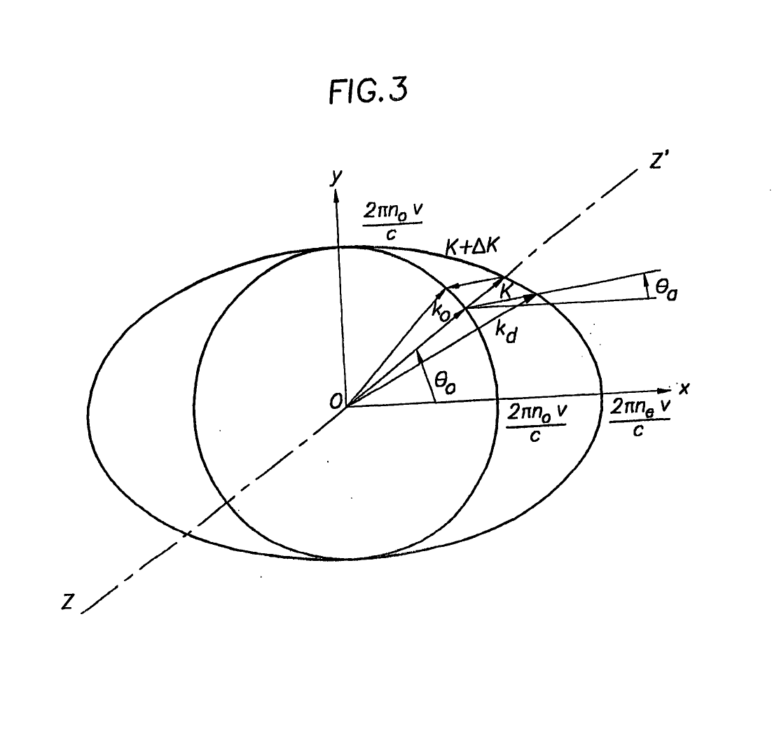

FIG. 3 represents to the nearest factor the curves of the ordinary and extraordinary indices of a double refracting uniaxial crystal;

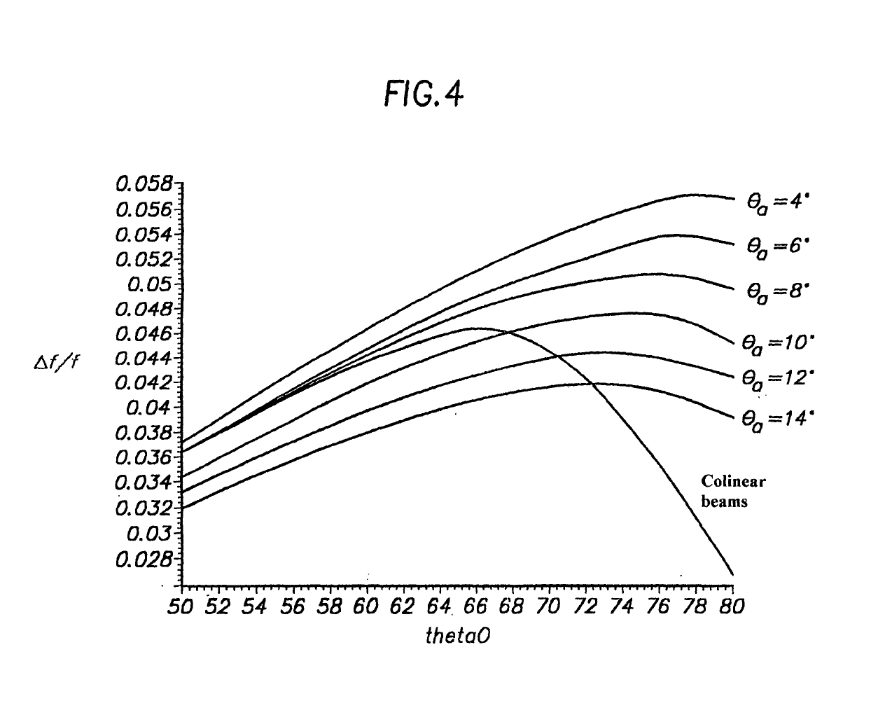

FIG. 4 is a diagram representing the relative variation of the frequency Δf/f according to the incidence angle θ₀ for various values of θₐ between 4° and 14°;

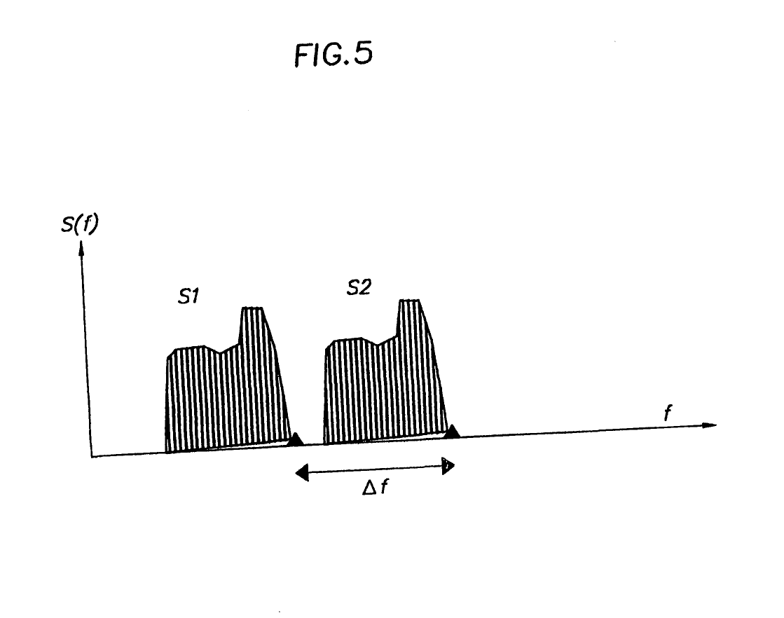

FIG. 5 shows an example of the spectrum S(f)

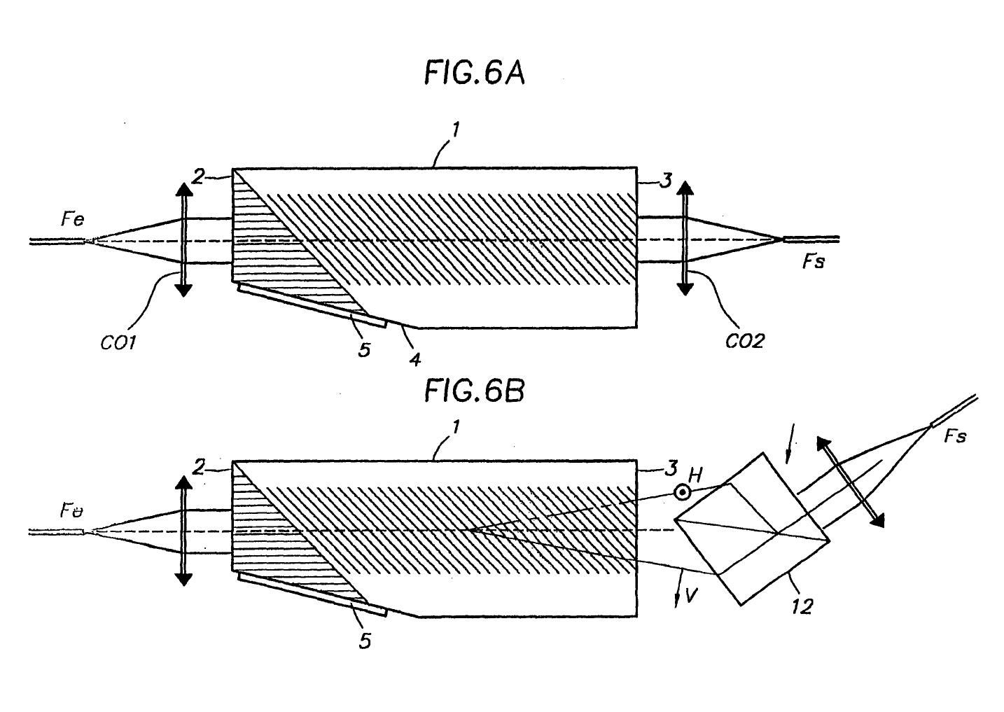

FIGS. 6A and 6B show the optical mountings of FIGS. 1 and 2 equipped with input and output collimation systems allowing coupling on optical fibres.

In the examples shown on FIGS. 1 and 2, the light modulation device introduces a double refracting acousto-optic crystal 1 with tellurium dioxide TeO₂ having an elongated parallelpiped shape including one input face 2, one output face 3 and a round angle 4 adjacent to the input face 2 whose oblique face is equipped with a piezo-electric transducer 5.

The direction of the acoustic wave vector here makes an angle of between 75° and 85° with the optical axis Oy of the crystal 1 (FIG. 3).

Applied to the input face 2 of the crystal is a polarised light beam (vector P) whose components are represented on the ordinary axis H and on the extraordinary axis V.

This light wave propagates inside the crystal 1 and comes out via the output face 3.

In the example shown on FIG. 1, at the outlet of the crystal 1, a semi-reflecting mirror 6 is placed inside the axis of the optical input signal (propagation axis ZZ′). This semi-reflecting mirror 6 orientated at 45° with respect to said axis, transmits a fraction of the output signal (direct signal transmitted) onto an optical spectrum analyser 7 coupled to a computer 8 which also receives information from an analyser of the response of the transmission channels 9. This computer 8 controls a generator for generating signals RF 10 applied to the piezo-electric transducer 5.

This figure also shows the two optical waves D, D′ diffracted inside the crystal 1, one with the polarisation H′ originating from the component V of the optical input wave, the other with the polarisation V′ originating from the component H of the optical input wave.

In the example shown on FIG. 2, instead of transmitting to the analyser 7 a fraction of the direct output transmitted signal, a signal is applied to the latter, this signal resulting from recombining the two diffracted waves D, D′ by means of mixing optics (recombination device 12). The recombined signal is then processed similarly to that of the output signal fraction of the example shown on FIG. 1.

First of all, it ought to be mentioned that a modulation of the light by means of an acousto optic interaction is today used in a large number of applications, such as modulators and light deflectors, adjustable filters and spectrum analysers, as described in sections 9 and 10 of the book “Optical waves in crystals” by A. Yariv and P. Yeh (Published by John Wiley & Sons Inc, 1984).

The functioning of the programmable acousto-optic filter (AOPEF) is based on a collinear or quasi-collinear acousto-optic interaction in a double refracting acousto-optic crystal intended to maximise the effective interaction length between an optical input wave Eᵢₙ(t) and a programmable acoustic wave which spatially reproduces the shape of the electric signal S(t) applied to the piezo-electric transducer of the component (FIGS. 1 and 2).

A diffracted output optical wave is only generated at a point of the crystal 1 when the phase coherence conditions between the optical input wave and the acoustic wave are embodied, as described in the book by A. Yariv and P. Yeh (ibid, pages 177-189).

When polarisation of the optical input wave is unknown, as in often the case in the transmission fibres of WDM communication systems, two optical output waves are diffracted, one with the polarisation H′ originating from the component V of the optical input wave and the other with the polarisation V′ originating from the component H of the optical input wave.

In a double refracting crystal 1, the two components H and V of the optical input wave do not propagate at the same speed: the component H propagates for example at ordinary speed whereas the component V propagates at extraordinary speed. Thus, the phase agreement between the acoustic wave and the two components H and V of the optical input wave does not occur for the same acoustic frequency for the two polarisations, this acoustic frequency difference Δf can be effective to separately process the two components H and V of a given optical input wave.

More specifically, the invention proposes using an acoustic modulation signal in which one portion of its spectrum is coupled with the component H of the optical input wave, whereas another separate portion of this modulation spectrum is coupled with the component V of the optical input wave.

The functioning of the device shall be more readily understood by referring to FIG. 3 which represents for a double refracting unixial crystal the curves of the ordinary index (a circle with radius no) and extraordinary index (an ellipse with a major axis nₑ and a minor axis n₀) multiplied by

$$\frac{2 π v}{c}$$

inside a plane containing the optical axis c of the crystal (axis Oy of FIG. 3).

The phase agreement between an ordinary incident wave H with a wave vector \vec{k}₀ and modulus

$$\vert {k}_{o} \vert = \frac{2 π {n}_{o} v}{c}$$

an acoustic wave with a wave vector \vec{K} and a modulus

$$\vert K \vert = \frac{2 π f}{v}$$

and an extraordinary diffracted optical wave with a wave vector \vec{k}_{d} and modulus

$$\vert {k}_{d} \vert = \frac{2 π {n}_{d} v}{c}$$

is written: \vec{k}₀+\vec{K}=\vec{k}_{d}, v and f being respectively the optical and acoustic frequencies, c and v the phase speeds of the light in the vacuum and of the acoustic wave in the propagation direction, and n_{d} the index of the extraordinary wave in the diffracted direction.

If θ₀ and θₙ are the angles of the vectors \vec{k}₀ and \vec{K} with the axis Ox and if the ratio

$$\frac{( {n}_{e} - {n}_{o} )}{{n}_{0}} = \frac{Δ n}{{n}_{o}}$$

is small in front of 1, it can be mathematically shown that:

$$\frac{Δ f}{f} = \frac{Δ K}{K} = - \frac{Δ n}{{n}_{o}} {cos}^{2} {θ}_{0} tan ( {θ}_{0} - {θ}_{a} ) [ 2 tan {θ}_{0} - tan ( {θ}_{0} - {θ}_{a} ) ]$$

ΔK is the length variation of the vector \vec{K} between the diffraction of the ordinary wave H of the angle of incidence θₒ towards the extraordinary wave V′ and the diffraction of the extraordinary wave V with the same angle of incidence θₒ towards the ordinary wave H′. Δf/f is the relative variation of the acoustic frequency f associated with the vector \vec{K}.

On FIG. 4, in the case of a tellurium dioxide crystal and for a transversal acoustic wave with polarisation perpendicular to the plane of the figure, the relative variation of the frequency Δf/f has been plotted according to θₒ for various values of θₐ between 4° and 14°.

Furthemore, this figure shows that Δf/f has been plotted according to θₒ when the “Poynting” vectors of the optical input wave and the acoustic wave are aligned, that is when the condition:

$$tan {θ}_{0} = \frac{{v}_{x}^{2}}{{v}_{y}^{2}} tan {θ}_{a}$$

is satisfied, vₓ and v_{y} being the acoustic speeds of propagation of the transversal wave respectively along the axes Ox and Oy.

This additional condition makes it possible to maximise the effectiveness of the acoustic optic interaction.

It is then possible to observe on FIG. 4 that, for a colinear or quasi-colinear beam interaction in the tellurium dioxide, the maximum value of Δf/f is obtained for: θₒ=65° and θₐ=10° and worth about: 4.6%, namely expressed in optical wavelengths by taking account of Δλ/λ=Δf/f: Δλ=70 nm around λ=1.55 μm.

According to the invention, as regards the functioning of the AOPEF and to the extent that the diffracted output waves are of low intensity compared with the optical input wave intensity, the AOPEF embodies a convolution between the amplitude of the optical input signal Eᵢₙ(t) and a signal S(t/α) derived from the electric signal S(t) applied to the piezo-electric transducer of the component, as described in the article by P. Tournois and entitled “Acousto-optic programmable dispersive filter for adaptive compensation of group delay time dispersion in laser systems” which appeared in Optics Communications on Aug. 1, 1997, p. 245-249 and in the article by F. Verluise and al and entitled “Amplitude and phase control of ultrashort pulses by use of an acousto-optic programmable dispersive filter; pulse compression and shaping” which appeared in Optics Letters on Apr. 15, 2000, p. 575-577, namely:

E_{diffracted}(t)=Eᵢₙ(t)⊕S(t/α)

In the field of frequencies, this convolution is written:

E_{diffracted}(ν)=Eᵢₙ(ν).S(f), with

$$\begin{matrix}{E}_{diffracted}^{V} ( v ) = {E}_{in}^{H} ( v ) \cdot {S}_{1} ( f ) = {E}_{in}^{H} ( v ) \cdot {S}_{1} ( α \cdot v ) \\ {E}_{diffracted}^{H} ( v ) = {E}_{in}^{V} ( v ) \cdot {S}_{2} ( f ) = {E}_{in}^{V} ( v ) \cdot {S}_{1} ( f - Δ f ) = {E}_{in}^{V} ( v ) \cdot {S}_{1} ( α \cdot v - Δ f )\end{matrix}$$

S₁(f) and S₂(f) are two functions without covering, one being obtained from the other via translation along the axis of the frequencies. α is a scale factor equal to the ratio of the speed v of the sound to the speed c of the light multiplied by the difference δn of the ordinary and extraordinary indices taken on the axis of propagation selected in the double refracting crystal of the component:

$$α = \frac{f}{v} = \frac{δ n - v}{c}$$

The extremely low value of α of about 10⁻⁷ makes it possible to control optical signals of several hundreds of THz with electric signals of several tens of MHz.

FIG. 5 shows an example of a spectrum S(f) comprising one component 1S₁(f) and one component 2S₂(f), both out-of-joint and one being translated with respect to the other as regards the quantity Δf defined earlier. For this type of signal S(t), a given modulation is applied to the two components H and V of the optical input wave.

A large number of crystals can be used, such as lithium niobate, calcium molybdate and tellurium dioxide TeO₂. This last-mentioned substance results in obtaining a particularly significant acousto-optic efficiency for a colinear or quasi-colinear interaction according to the “Poynting” vectors of the optical and acoustic beams in the case of the slow transverse acoustic wave and shall preferably be used to embody the invention.

In the application for equalisation of the amplitude of the optical communication channels of the invention:

when the signal used at the outlet of the component is the non-diffracted transmitted direct signal (FIG. 1), the acoustic signal applied to the AOPEF needs to be continuous and only bears spectral amplitude information |S(f)| so that in (in the convolution approximation):

|Eₒᵤₜ(ν)|²_{direct}=|Eᵢₙ(ν)|²·└1−|S(f)|²┘=Cste

when the signal used at the outlet of the component is a recombination of the diffracted signals H′ and V′ (FIG. 2), the acoustic signal applied to the AOPEF needs to be continuous and only bears spectral amplitude information |S(f)| so that:

|Eₒᵤₜ(ν)|²_{recombined}=|Eᵢₙ(ν)|²·|S(f)|²=Cste

Thus, the best adapted electric signal S(t) is

either a signal whose spectrum comprises a phase which varies randomly or pseudo-randomly over a period of time with a correlation time much shorter than the acoustic propagation time in the crystal,

or a periodic signal with a period strictly equal to the acoustic propagation time in the interaction zone of the crystal.

In the case where the transmission coefficient of the optical input wave towards the diffracted waves is high and where the approximation of convolution does not apply, the acoustic signal is more complex, but an adaptive counter-reaction looping system using a suitable convergence algorithm makes it possible to attain equalisation, as described in the article by W. Yang and al and entitled “Real time adaptative amplitude feedback in an AOM based ultra short pulse shaping system which published in IEEE Photonics Technology Letters, volume 11, N° 12, December 1999, p 1665-1667.

The devices of FIGS. 1 and 2 and needing to be coupled to fibres Fe, Fs at the inlet and outlet of the devices of the collimation systems CO₁, CO₂ having their collimation axis merged (FIG. 6A) or not (collimation systems CO₃, CO₄, FIG. 6B) shall allow this coupling.

In the case of the solution shown on FIG. 6B, the collimation system CO₄ is placed at the outlet of the recombination device 12.

Finally, shown by digital examples for a wavelength λ=1.55 μm, that is an optical frequency ν=193.5 THz and cutting of the TeO₂ crystal which renders colinear the propagation of the optical input signal and the propagation of the acoustic energy for which α=1.4 10⁻⁷, the central acoustic frequency to be applied to the transducer is:

f=α·ν=27 MHz

If the passband to be equalised is Δλ=70 nm, the passband Δf_{H} of the electric signal to be applied to the transducer is:

$$Δ {f}_{H} = \frac{Δ λ}{λ} \cdot f = 1 , 2 MHz$$

For the component H of the polarisation vector of the optical input wave and Δfν for the component V, namely in all Δf=2.4 MHz since the two modulation spectra S₁ and S₂ are out-of-joint.

If L is the colinear interaction length in the crystal, that is approximately the length of the crystal, the number of independent spectral programming points N intended to modulate the signal S(t) in the equalisation band is given for this cutting of the TeO₂ by:

$$N = \frac{1}{20} \cdot \frac{Δ λ}{λ} \cdot \frac{L}{λ}$$

namely N=14.5 points per cm of crystal length for each of the polarisations H and V.

The acoustic power density P to be applied to the transducer for a diffraction effectiveness of 100% is given by:

$$P = 7.5 \cdot {10}^{4} \cdot \frac{Δ λ}{L} in W \text{/} {mm}^{2} .$$

namely about 0.5 W/mm² for Δλ=70 nm and L=1 cm.

1. Programmable acousto-optic device comprising a double refracting elasto-optical medium (1) provided with a transducer (5) capable of generating inside the elasto-optical medium (1) an acoustic wave modulated along a specific direction, as well as means for coupling in the elasto-optical medium (1) of an optical input wave with unknown polarisation unknown components H and V projected onto the fast and slow axes of the double refracting medium, characterised in that the device comprises a circuit (8, 10) for programming the modulation, namely amplitude-frequency-phase, of the acoustic wave and provides three optical output waves: one direct wave with the same polarisation as that of the optical input wave, and two diffracted waves with polarisation H and V respectively and perpendicular to each other, each bearing an amplitude and frequency or phase modulation of their spectrum which depends on both modulation of the optical input wave and modulation of the acoustic wave.

2. Device according to claim 1, characterised in that modulation of the spectrum of the acoustic wave is programmed so as to compensate amplitude distortions or modify the shape of the spectrum of the various transmission channels of wavelength-multiplexed optical communications systems.

3. Device according to claim 1 or 2, characterised in that the effective optical output beam bearing the result of shaping or equalisation is the non-diffracted direct beam transmitted.

4. Device according to claim 1 or 2, characterised in that the two diffracted output waves with polarisation H and V are recombined (recombination device 12) along a single output wave with polarisation basically identical to that of the optical input wave.

5. Device according to one of claims 1 to 4, characterised in that it comprises an adaptative circuit comprising a measurement of the optical spectrum (analyser 12) at the outlet of the device or a measurement of the response of the transmission channels (analyser 9), and a counter-reaction circuit acting on the programming circuit (8, 10) of the device so as to equalise or optimise the optic energy in all channels.

6. Device according to one of claims 1 to 4, characterised in that one portion of the spectrum of modulation of the acoustic wave is used to shape or equalise the component with polarisation of the incident optical wave, and in that another separate portion of the spectrum of modulation of the acoustic wave is used to shape or equalise the component V with the polarisation of the incident wave.

7. Device according to one of claims 1 to 4, characterised in that the inlet and outlet of the device are collimated beams derived from optical fibres whose collimation axes are merged or not merged.

8. Device according to claim 1, characterised in that the direction of propagation of the energy of the acoustic wave is colinear or quasi-linear with the direction of propagation of the energy of the optical input wave in their interaction zone.

9. Device according to one of claims 1 to 8, characterised in that the elasto-optical medium is composed of tellurium dioxide and the direction of the acoustic wave vector forms an angle of between 75° and 85° with the optical axis of the crystal.

10. Device according to claim 1 or 2, characterised in that modulation of the acoustic spectrum comprises a phase which varies over a period of time randomly or pseudo-randomly with a correlation time much shorter than the acoustic propagation time in the crystal.

11. Device according to claim 1 or 2, characterised in that the acoustic signal is periodic with a period equal to the acoustic propagation time in the interaction zone of the crystal (1).
